(19) United States
(12) Patent Application Publication
(10) Pub. No.: US 2009/0263651 A1
(43) Pub. Date: Oct. 22, 2009

(54) OPTICALLY TRANSPARENT RESILIENT LAMINATE MATERIALS AND METHODS OF MANUFACTURE

(76) Inventor: Richard L. Cook, Flagstaff, AZ (US)

Correspondence Address: THE NOBLITT GROUP, PLLC, 4800 NORTH SCOTTSDALE ROAD, SUITE 6000, SCOTTSDALE, AZ, 85251, US

(21) Appl. No.: 12/366,863

(22) Filed: Feb. 6, 2009

Related U.S. Application Data
(60) Provisional application No. 61/026,612, filed on Feb. 6, 2008.

(51) Int. Cl. B32B 27/36; B32B 17/10; B32B 37/12

(52) U.S. Cl. 428/339; 428/412; 156/60

(57) ABSTRACT

In accordance with an exemplary embodiment of the present invention, an optically clear polyurethane/polyurea polymer may comprises an impact resistant material comprising: a first polycarbonate layer; a second layer comprising a first elastomer; a third glass layer; a fourth layer comprising a second elastomer; and a fifth polymeric layer. In another exemplary embodiment, the third glass layer may be articulated and/or embedded in the second layer. Disclosed features and specifications may be variously controlled, adapted or otherwise optionally modified to improve and/or modify the performance characteristics of the transparent armor composite. Exemplary embodiments of the present invention generally provide lightweight transparent armor for use as, for example, bulletproof windows in vehicles and buildings.

### CROSS REFERENCES TO RELATED APPLICATIONS

This application claims the benefit of U.S. Provisional Patent Application No. 61/026,612, filed Feb. 6, 2008, and incorporates the disclosure of such application by reference.

### FIELD OF THE INVENTION

The present invention generally provides improved systems, devices, compositions, and methods for providing optically transparent resilient polymers; and more particularly, representative and exemplary embodiments of the present invention generally relate to bullet resistant windows or laminate materials. In one aspect, various representative embodiments of the present invention relate to bullet resistant windows for armored vehicles. In a further aspect, other representative embodiments of the present invention relate to transparent armor useful in military and security vehicles. In yet a further aspect, still other representative embodiments of the present invention relate to architectural structures for security or damage resistant purposes.

### BACKGROUND OF INVENTION

Security has become increasingly important. With respect to vehicle structures in general, military vehicles require greater than average protection for its occupants. This has given rise to various transparent armor structures for windshields and side windows that are designed to resist the incursion of: small arms projectiles, shrapnel, debris from the road, projectiles thrown to vandalize the vehicles, and the like objects.

In constructing transparent armor, “bullet proof glass” composites may comprise of tempered glass and plastic layers bonded together to form complex laminated composites. The resulting composites are generally transparent and substantially free of optical distortion, but still maximize the ballistic protection from “penetrators.” In operation, the inner and outer layers of the composite can also be subjected to shock, scratching, abrasion and adverse weather conditions particularly when the transparent armor composite is used in grueling military applications.

The various layers used in the composite may be chosen for their different projectile resisting characteristics and Functions. For example, glass layers are hard and thus readily erode bullets and are highly abrasion resistant; however, glass layers are brittle and spall when struck by a projectile that penetrates the glass layers, which produces sharp shrapnel fragments. As a result of an impact, the shrapnel fragments often spread at a high rate of speed, and as a consequence can be more dangerous to the vehicle occupants than the original projectile. Traditionally, heavy glass in thicknesses of at least 0.5 inch were used to blunt bullets, which were either stopped by the glass or a thermoplastic backing. The resultant peripheral damage, both balistically and optically was severe and broad in scope. However, by incorporating plastic material layers as part of the composite, some flexibility of the transparent armor composite can be obtained. The addition of one or more plastic layers to the composite may also alter the failure mode of the transparent armor so any failure that may occur, will do so in a more ductile manner rather than spalling. Acrylic, polyurethane and polycarbonate based materials are among the plastic (polymeric) materials which have been shown to have utility in making transparent armor composites.

One class of plastics that proves both useful and reliable for constructing transparent armor structures is polycarbonate. Polycarbonate demonstrates superior characteristics for many applications to provide for overall protection because it maintains protective integrity along a wide range between its brittleness transition temperature and its heat distortion temperature. For example, applications such as transparent and/or translucent armor, vehicle glazings, architectural glazings, riot shields, aircraft canopies, face masks, visors, ophthalmic and sun lenses, protective eyewear and/or the like, may benefit from such polycarbonate material.

### SUMMARY OF THE INVENTION

In representative aspects, the present invention provides systems, devices, compositions, and methods for providing bullet resistant windows comprising a hard resilient outer surface coating of a polycarbonate overlaying a soft elastomer comprising embedded articulated glass material, or the polycarbonate may overlay a soft elastomer that subsequently overlays a glass material, wherein the glass comprises either a sheet or an articulated form. These may then overlay a layer of thick impact resistant polymer backing. The resulting laminated composite comprises the capability to resist small arms fire at close range and/or other harmful debris.

Advantages of the present invention will be set forth in the Detailed Description which follows and may be apparent from the Detailed Description or may be learned by practice of exemplary embodiments of the invention. Still other advantages of the invention may be realized by means of any of the instrumentalities, compositions, methods or combinations particularly disclosed herein.

### BRIEF DESCRIPTION OF THE DRAWINGS

Exemplary elements, operational features, applications and/or advantages of the present invention reside inter alia in the details of construction and operation as more fully hereafter depicted, described or otherwise identified—reference being made to the accompanying drawings, images, figures, etc. forming a part hereof (if any), wherein like numerals (if any) refer to like parts throughout. Other elements, operational features, applications and/or advantages will become apparent in view of certain exemplary embodiments recited in the disclosure herein.

FIG. 1 representatively illustrates a cross-section view of a substantially optically transparent armor composite in accordance with an exemplary embodiment of the present invention;

FIG. 2 representatively illustrates a cross-section view of a substantially optically transparent armor composite in accordance with another exemplary embodiment of the present invention;

FIG. 3 representatively illustrates a cross-section view of another substantially optically transparent armor composite in accordance with yet another exemplary embodiment of the present invention; and

FIG. 4 representatively illustrates a flow chart of a method for manufacturing an optically transparent armor composite in accordance with an exemplary embodiment of the present invention.

It will be appreciated that elements in the drawings, images, figures, etc. are illustrated for simplicity and clarity and have not necessarily been drawn to scale. For example, the dimensions of some of the elements in the figures may be exaggerated relative to other elements to help improve understanding of various embodiments of the present invention. Furthermore, the terms ‘first’, ‘second’, and the like herein, if any, are used inter alia for distinguishing between similar elements and not necessarily for describing a sequential or chronological order.

Moreover, the terms ‘front’, ‘back’, ‘top’, ‘bottom’, ‘over’, ‘under’, and the like in the disclosure and/or in the provisional embodiments, if any, are generally employed for descriptive purposes and not necessarily for comprehensively describing exclusive relative position. It will be understood that any of the preceding terms so used may be interchanged under appropriate circumstances such that various embodiments of the invention described herein, for example, are capable of operation in other configurations and/or orientations than those explicitly illustrated or otherwise described.

### DETAILED DESCRIPTION OF EXEMPLARY EMBODIMENTS

The following representative descriptions of the present invention generally relate to exemplary embodiments and the inventor's conception of the best mode, and are not intended to limit the applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

In accordance with exemplary embodiments of the present invention, an impact resistant composite may comprise of a multi-layered assembly comprising a polycarbonate facing and an elastomeric under layer, wherein the elastomeric under layer either overlays a glass layer or comprises articulated glass elements embedded in the elastomeric under layer. These layers are then further layered over a relatively thick impact resistant polymeric layer or plurality of impact resistant polymeric layers. Thus, when a projectile strikes an exemplary composite, spalling is mitigated.

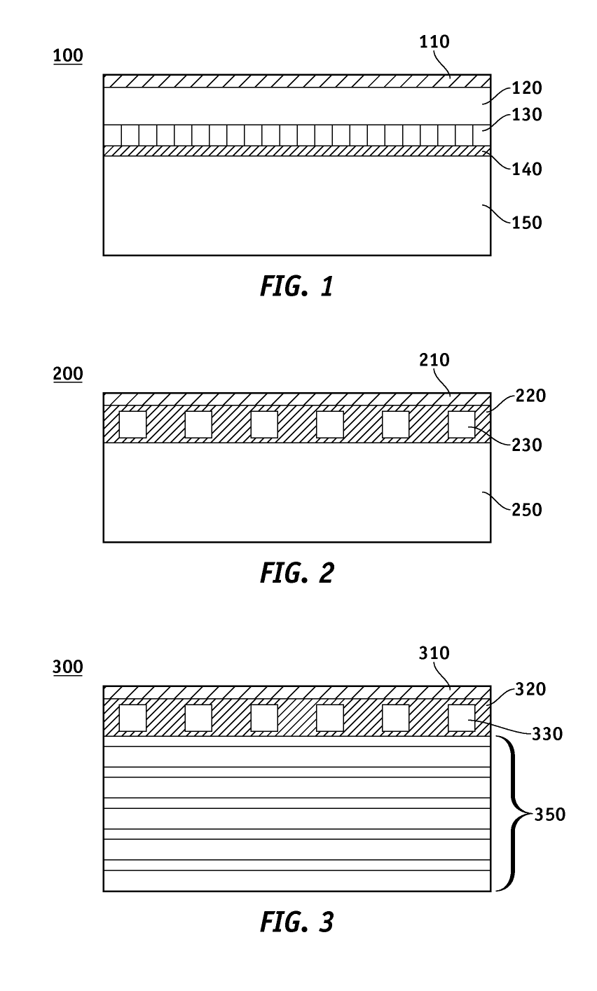

In accordance with an exemplary embodiment of the present invention and with reference to FIG. 1 an impact resistant composite 100 may comprise a hard, resilient outer surface facing layer 110, for example, a polycarbonate, which may further overlay a relatively soft elastomer layer 120. These layers may further overlay a glass layer 130 and another relatively soft elastomer layer 140. This laminate may then overlay a relatively thick, impact resistant, polymer backing 150 to complete the composite construction in accordance with the present invention.

In accordance with exemplary embodiments, the racing layer 110, generally comprises of sufficient thickness to blunt the pointedness of a bullet, and comprises relatively highly cut and puncture resistance material. In an exemplary embodiment, the facing layer 110 may comprise a polycarbonate, for example, a Lexan® polycarbonate. The polycarbonate may comprise a thickness from about 0.07 to about 0.1 inches thick, and more particularly may comprise a thickness of about 0.09 inches thick. In another exemplary embodiment, the facing layer 110 may comprise a biaxially-oriented polyethylene terephthalate material, for example, Mylar®. The Mylar® may comprise a thickness from about 0.007 to about 0.010 inches thick, and more particularly may comprise a thickness of about 0.008 inches thick. In yet another exemplary embodiment, the facing layer 110 may comprise a cellulose acetate butyrate material comprising a thickness from about 0.008 to about 0.012 inches thick, and more particularly may comprise a thickness of about 0.01 inches thick. Other exemplary embodiments may comprise similar materials configured to achieve similar results, as well as varying thicknesses to function in accordance with the present invention.

In accordance with exemplary embodiments, the facing layer 110 may be suitably configured to contain spalls so that initial and subsequent impacts may be able to strike at least a portion of the hard facing layer 110 surface, whether or not it has been previously fractured. The facing layer 110 may also be suitably configured to restrict lateral loss of the acing layer 110 material, thereby maintaining optical clarity of the composite 100 when it is struck by smaller debris. This results in a reduced need to replace the armored composite prior to it actually being struck by a bullet. Furthermore, the facing layer 110 may attenuate, absorb, and/or distribute the force from the shock wave induced by the impact from a projectile to prevent, deter, and/or minimize fracture of the glass layer 130 and/or other composite layers.

In accordance with an exemplary embodiment of the present invention, the facing layer 110 may bond to a glass layer 130 by a relatively soft elastomer layer 120 that may comprise high elongation characteristics. The elastomer layer 120 may comprise of a urethane polymer comprising a thickness from about 0.05 to about 0.30 inches thick. Among various exemplary embodiments, the facing layer 110 may be bonded to the glass layer 130 by the elastomer layer 120, wherein the elastomer layer 120 may comprise sufficient strength and thickness to, for example, facilitate catching a blunted bullet, wherein the blunted bullet may be blunted by the facing layer 110.

In accordance with an exemplary embodiment of the present invention, the glass layer 130 may bond to the facing layer 110 by the elastomer layer 120 and may also bond to the polymer backing 150 by a second elastomer layer 140. Among various exemplary embodiments, the second elastomer layer 140 may comprise similar material characteristics as the elastomer layer 120, but in other embodiments other elastomers comprising similar or varying thicknesses may be used, whether now known or otherwise hereafter described in the art, may be alternatively, conjunctively or sequentially employed to achieve a substantially similar result.

In accordance with an exemplary embodiment, the two layers of high elongation elastomeric material, for example elastomer layers 120 and 140, may comprise a urethane polymer separated by the glass layer 130. The elastomer material may be of sufficient strength and thickness to contain glass spall and to further facilitate catching a blunted bullet. It should be noted that the primary reason for high elongation of the elastomer layers is to accommodate the vast difference in expansion coefficient between the facing layer 110 and the glass layer 130, and also between the glass layer 130 and the polymer backing 150.

In accordance with an exemplary embodiment, the layer 130 may comprise a glass material. For example, the glass material may comprise borosilicate, soda lime, crown, aluminum oxynitride, sapphire, and any glass material, whether now known or otherwise hereafter described in the art, which may be alternatively, conjunctively or sequentially employed to achieve a substantially similar result. Among various exemplary embodiments, the glass layer 130 may comprise a thickness that depends upon specific applications. For example, the glass layer 130 may comprise a thickness from about 1/16 to about ½ inches thick.

In accordance with another exemplary embodiment and with reference to FIG. 2, the present invention may provide for restricted lateral damage to a composite 200 by articulating a glass layer 230. An articulated (mosaic) layer 230 of glass material may be embedded in a high elongation elastomeric material 220 comprising, for example, a urethane polymer, which may also be similar to the elastomer material described, for example, elastomer layers 120 and 140. The articulated glass layer 230 may comprise a glass material similar to the glass layer 130 or any other glass material, whether now known or otherwise hereafter described in the art, which may be alternatively, conjunctively or sequentially employed to achieve a substantially similar result. Moreover, the articulated glass layer 230 may also comprise a similar thickness range as glass layer 130, but other thicknesses whether now known or otherwise hereafter described in the art, may be alternatively, conjunctively or sequentially employed to achieve a substantially similar result.

In accordance with exemplary embodiments of the present invention and with return reference to FIG. 1, the composite 100 may comprise a relatively thick, impact resistant, polymer backing 150. In an embodiment, the polymer backing 150 may comprise a thickness from about 2.5 to about 3 inches. The polymer backing may comprise of a tough, semi-rigid material comprising a high cut and puncture resistance capable of “catching” the blunted projectile by depleting its kinetic energy. In one example, the polymer backing may comprise a polycarbonate material similar to the facing layer 150, but other polymer backings whether now known or otherwise hereafter described in the art, may be alternatively, conjunctively or sequentially employed to achieve a substantially similar result.

In an example, a single casting of a clear, hard urethane polymer may comprise an exemplary material for backing layer 150 that may be employed in accordance with various exemplary embodiments of the present invention. Hard urethane has demonstrated ease of casting and provides superior close-strike resiliency. Other materials comprising Similar characteristics (e.g., polycarbonate and acrylic), whether now known or otherwise hereafter described in the art, may be alternatively, conjunctively or sequentially employed to achieve a substantially similar result.

In accordance with exemplary embodiments of the present invention and with reference to FIG. 3, the composite 300 comprising a polymer backing may alternately comprise of a multi-ply backing 350. The multi-ply backing 350 may comprise of similar materials used for polymer backing 150, other comparable polymer backing materials, or any combination thereof whether now known or otherwise hereafter described in the art, which may be alternatively, conjunctively or sequentially employed to achieve a substantially similar result. In some exemplary embodiments, the multi-ply backing 350 may comprise materials that increase in ductility for each subsequent layer of the multi-ply backing, or in other embodiments, the multi-ply backing 350 may comprise materials that decrease in ductility for each subsequent layer. Moreover, the various layers of the multi-ply backing 350 may comprise similar thicknesses or comprise varying thicknesses. For example, a first ply may be thicker than a second ply which may be thicker than a third ply, etc., or vice versa.

In accordance with exemplary embodiments, the multi-ply backing 350 individual layers may be bonded to each other by a thin layer of elastomer material, for example, elastomer material similar to the material comprising elastomer layer 120, 140, and/or elastomer layer 220, as well as other materials suitably configured to bond the various multi-ply backing 350 layers together. Other materials now known or otherwise hereafter described in the art, may be alternatively, conjunctively or sequentially employed to achieve a substantially similar result.

In accordance with the various exemplary embodiments described, it should be noted that the term “projectile” may refer to any object that may strike the surface of an optically transparent armor composite assembly. These may include projectiles used to attack the integrity of the optically transparent armor composite such as ballistic items (bullets, shrapnel, thrown objects such as bricks, stones and other similar objects) and self-propelled items (such as RPGs, missiles, and other rocket-like objects). Projectiles may also include objects used to directly strike the surface of the optically transparent armor, such as, for example: bricks, metal objects, stones, etc. Finally, projectiles may also include other objects that come into contact with the surface of the optically transparent armor composite. For example, if the optically transparent armor composite is used as part of a vehicle and that vehicle were to be involved in an accident; projectiles may comprise parts of other vehicles, a road, buildings or other objects that strike the surface of the composite.

In accordance with exemplary embodiments of the present invention, an optically transparent armor composite may comprise the various layers to comprise indicies of refraction that are substantially similar. An important concern involves matching the indices of refraction of the polymeric facing material, glass material, and elastomeric layers to optimize the optical clarity of the armored composite. In this manner, any distorted viewing across the composite may be minimized by selecting materials that not only provide superior ballistic stoppage capabilities, but also comprise substantially similar indicies of refraction. It has been found that when the outer hard resilient facing layer comprising polycarbonate is combined with the elastomeric layers and the glass material layer, a good refractive match may be achieved. This suggests that a very thin surface of the outer hard resilient facing layer may also be used over any articulated glass core.

In one example, the various armor composites described may comprise of a borosilicate glass as the glass layer material, wherein the borosilicate glass may, for example, comprise a refractive index of about 1.48. In this example, to provide for optimal viewing performance, the facing layer (110, 210 and/or 310), the backing layer (150, 250 and/or 350), and the elastomer layers (120, 140, 220, and/or 320) may comprise of materials comprising substantially similar indicies of refraction to the glass layer, e.g. comprising of a refractive index of 1.48±0.05. Furthermore, by addition of low refractive index plasticizers, for example, by addition to the elastomeric layers, the index of refraction match can be nearly perfect.

In accordance with an exemplary embodiment, an articulated glass layer embodiment may comprise closely matching the indices of refraction of the optically transparent glass tile elements with that of the polymer matrix to eliminate or otherwise reduce optical distortions across articulated glass element boundaries. For example, by viewing through the composite at a vantage point that is normal to the various layers, the articulated glass layer will not inhibit the clarity of viewing. In other words, by looking straight on through the articulated glass layers, any boundaries may only be slightly perceptible as thin lines. Thus, as long as each of the composite layers is transparent, viewing is not distorted. However, if the indices of refraction are not closely matched, looking “across” or at an angle to the boundaries of the articulated glass layer could significantly hinder viewing through the composite.

In accordance with exemplary embodiments of the present invention, optically transparent armor composite assemblies may be constructed using vacuum and/or autoclave processes of laminate stack-ups. The stack-ups may comprise a combination of the glass layer, the polymeric facing and inner-layers, and the polymeric backing layer as described. Various other embodiments of the present invention may also be manufactured with conventional equipment, and methods such as open face casting and/or a resin transfer method may be likewise employed.

In accordance with an exemplary embodiment, an optically transparent armor composite assembly may be constructed by open face pouring an uncured elastomer (inter-layer material) onto a substrate, for example, a backing layer, then placing a subsequent layer, for example, the glass layer onto the pour. This may be done by canting the top layer onto the elastomer puddle and gradually decreasing the angle of impingement, thereby pushing the wet elastomer in a “wave” until the two substrate surfaces are parallel. This avoids entrapment of air bubbles.

In accordance with another exemplary embodiment, a more controllable method of assembly may be to clamp substrates together, for example, the facing layer, the glass layer, and/or the backing layer, using spacer shims around the edges to form adequate separation, and injecting the elastomer inter-layer material into the interstice. This allows the casting of compound contours and multiple layers in a single injection sequence. The operation can be accelerated by initiating the process at elevated temperatures and allowing cooling to occur as polymerization progresses. Initial cure can be achieved relatively quickly while still allowing quick de-mold times; final cure may then occur at room temperatures over a relatively long time period.

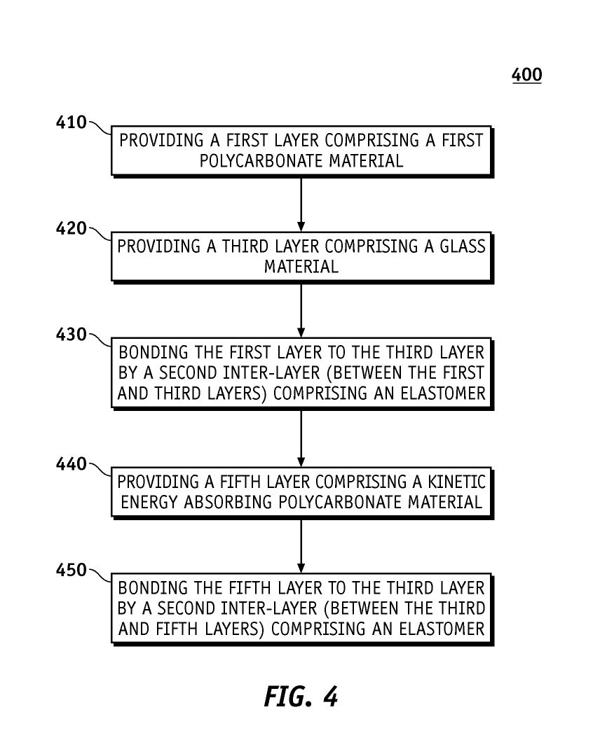

In accordance with an embodiment of the present invention and with reference to FIG. 4, an exemplary method 400 may comprise: providing a first layer comprising a first polycarbonate material (410); providing a third layer comprising a glass material (420); bonding the first layer to the third layer by a second inter-layer (between the first and third layers) comprising an elastomer (430), providing a fifth layer comprising a kinetic energy absorbing polycarbonate material (440); and bonding the fifth layer to the third layer by a second inter-layer (between the third and fifth layers) comprising an elastomer (450).

Particular implementations shown and described herein are illustrative of the invention and its best mode and are not intended to otherwise limit the scope of the present invention in any way. Indeed, for the sake of brevity, prepolymers, diamine curing agents, polyurethanes, polyureas and/or the like may not be described in complete detail herein.

In the foregoing specification, the invention has been described with reference to specific exemplary embodiments; however, it will be appreciated that various modifications and changes may be made without departing from the scope of the present invention as set forth in the exemplary provisional embodiments. The specification and figures are to be regarded in an illustrative manner, rather than a restrictive one and all such modifications are intended to be included within the scope of the present invention. Accordingly, the scope of the invention should be determined by the provisional embodiments and their legal equivalents. For example, the steps recited in any method or process embodiments may be executed in any order and are not limited to the specific order presented in the provisional embodiments. Additionally, the components and/or elements recited in any apparatus embodiment may be assembled or otherwise operationally configured in a variety of permutations to produce substantially the same result as the present invention and are accordingly not limited to the specific configuration recited in the provisional embodiments.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components of any or all the provisional embodiments.

As used herein, the terms “comprising”, “having”, “including”, or any contextual variant thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted by those skilled in the alt to specific environments, manufacturing specifications, design parameters or other operating requirements without departing from the general principles of the same.

We claim:

1. An impact resistant material comprising:
a first polycarbonate layer;
a second layer comprising a first elastomer;
a third glass layer;
a fourth layer comprising a second elastomer; and
a fifth polymeric layer.

2. The impact resistant material of claim 1, wherein the first layer comprises a thickness from about 0.07 inches to about 0.10 inches.

3. The impact resistant material of claim 1, wherein the second layer comprises a thickness from about 0.05 inches to about 0.30 inches.

4. The impact resistant material of claim 1, wherein the fifth layer comprises a thickness from about 2.5 inches to about 3.0 inches.

5. The impact resistant material of claim 1, wherein the first layer comprises a material selected from the group, Lexan®, Mylar®, and cellulose acetate butyrate.

6. The impact resistant material of claim 1, wherein the third glass layer comprises a thickness from about 1/16 to about ½ inches.

7. The impact resistant material of claim 1, wherein the third glass layer comprises a material selected from the group, borosilicate, soda lime, crown, aluminum oxynitride, and sapphire.

8. An impact resistant material comprising:
a first layer of a polycarbonate material;
a second layer of an elastomer comprising embedded articulated glass elements; and
a third layer comprising a kinetic absorbing polycarbonate material.

9. The impact resistant material of claim 8, wherein the first layer comprises a thickness from about 0.07 inches to about 0.10 inches.

10. The impact resistant material of claim 8, wherein the second layer comprises a thickness from about 0.05 inches to about 0.30 inches.

11. The impact resistant material of claim 8, wherein the third layer comprises a thickness from about 2.5 inches to about 3.0 inches.

12. The impact resistant material of claim 8, wherein the first layer comprises a material selected from the group, Lexan, Mylar, and cellulose acetate butyrate.

13. The impact resistant material of claim 8, wherein the embedded articulated glass elements comprises a thickness from about 1/16 to about ½ inches.

14. The impact resistant material of claim 8, wherein the glass elements comprises a material selected from the group, borosilicate, soda lime, crown, aluminum oxynitride, and sapphire.

15. A method for manufacturing an impact resistant material comprising:
providing a polycarbonate facing layer;
bonding a glass layer to the polycarbonate facing layer by a first elastomer;
providing a polymeric backing layer; and
bonding the polycarbonate backing layer to the glass layer by a second elastomer.

16. The method of claim 15, wherein the polycarbonate facing layer comprises a thickness from about 0.07 inches to about 0.10 inches.

17. The method of claim 15, wherein a layer of the first elastomer comprises a thickness from about 0.05 inches to about 0.30 inches.

18. The method of claim 15, wherein the polymeric backing layer comprises a thickness from about 2.5 inches to about 3.0 inches.

19. The method of claim 15, wherein the glass layer comprises a thickness from about 1/16 to about ½ inches.

20. The method of claim 15, wherein the glass layer comprises a material selected from the group, borosilicate, soda lime, crown, aluminum oxynitride, and sapphire.
